(19) United States
(12) Patent Application Publication
(10) Pub. No.: US 2003/0075163 A1
(43) Pub. Date: Apr. 24, 2003

(54) Saw blade with polycrystalline tips

(76) Inventors: Michael M. Sherman, Blowing Rock, NC (US); Jeremy A. Lowder, Boone, NC (US)

Correspondence Address: Joseph A. Sebolt, SAND & SEBOLT, Aegis Tower, Suite 1100, 4940 Munson Street, NW, Canton, OH, 44718-3615, US

(21) Appl. No.: 10/292,106

(22) Filed: Nov. 12, 2002

Related U.S. Application Data
(63) Continuation of application No. 09/626,753, filed on Jul. 27, 2000, now abandoned.

(51) Int. Cl. B28D 1/04

(52) U.S. Cl. 125/13.01

(57) ABSTRACT

A blade for a saw comprising a generally planar member having a rim with a plurality of teeth, wherein the improvement comprises a carbon composite material reinforcement positioned on at least one of the teeth. A method of using such a saw blade to cut a cement, ground sand and cellulosic fiber material is also disclosed.

This is a continuation of U.S. application Ser. No. 09/626,753, filed Jul. 27, 2000, the specification of which is incorporated herein by reference.

### BACKGROUND OF THE INVENTION

1. Technical Field

The present invention relates to cutting devices and more particularly blades which are used on such devices. Still more particularly, this invention relates to saw blades which are adapted for use on cellulosic fiber reinforced cement construction materials.

2. Background Information

Saw blades are commonly used to cut raw or processed materials into intermediate or final products. One class of materials which presents particular challenges to the cutting art are certain cellulosic fiber reinforced construction materials which are formed from compositions of cement, ground sand, and cellulosic materials. Such materials are commonly processed with various additives and water and are formed into boards and other useful shapes. One way in which such materials have been cut is with saw blades with a continuous rim design where a thin layer of serrated diamond is welded to the outside rim of the saw blade. Such saw blades, however, have disadvantages for such use in that they tend to heat quickly and are subject to warping when used to cut such cement, ground sand, and cellulosic fiber composite materials.

### SUMMARY OF THE INVENTION

It is an object of the present invention to provide a saw blade and a method for its use in which excessive heat and blade warping are avoided when cutting cement, ground sand, and cellulosic fiber composite materials.

It is another object of the present invention to provide a saw blade which cuts cement, ground sand, and cellulosic fiber composite materials cleanly and with a smooth finish without excessive burred and frayed edges.

This invention is a blade for a saw comprising a generally planar member having a rim with a plurality of teeth, wherein the improvement comprises a carbon composite material reinforcements positioned on at least one of the teeth.

### BRIEF DESCRIPTION OF THE DRAWINGS

The preferred embodiment of the invention, illustrative of the best mode in which applicant contemplated applying the principles, is set forth in the following description and is shown in the drawings and is particularly and distinctly pointed out and set forth in the appended claims.

FIG. 1 is a top plan view of a circular saw blade representing a preferred embodiment of the present invention;

FIG. 2 is a top plan view of a circular saw blade body used in the manufacture of the circular saw blade shown in FIG. 1;

FIG. 3 is a top plan view of the composite polycrystalline diamond and carbide reinforcement used in the manufacture of the circular saw blade shown in FIG. 1;

FIG. 4 is an end view of the composite polycrystalline diamond and carbide reinforcement shown in FIG. 3;

FIG. 5 is a side elevational view of the composite polycrystalline diamond and carbide reinforcement shown in FIG. 3;

FIG. 6 is a top plan view of the carbide only reinforcement used in the manufacture of the circular saw blade shown in FIG. 1;

FIG. 7 is an end view of the carbide only reinforcement shown in FIG. 6;

FIG. 8 is a side elevational view of the carbide only reinforcement shown in FIG. 6;

FIG. 9 is an enlarged view of the area in circle 9 in FIG. 1;

FIG. 10 is an enlarged view of the area in circle 10 in FIG. 1;

FIG. 11 is an end view from 11-11 in FIG. 9; and

FIG. 12 is an end view from 12-12 in FIG. 10.

### DESCRIPTION OF THE PREFERRED EMBODIMENTS

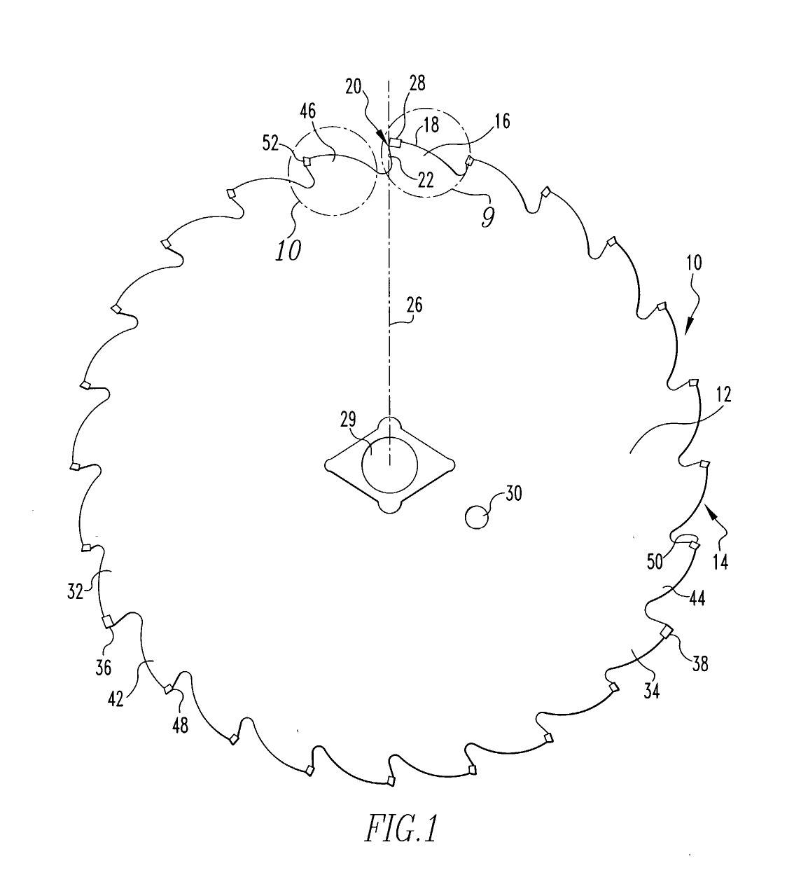

Referring to FIGS. 1, 9 and 10, the body of the saw blade is shown generally at numeral 10 wherein there are opposed planar surfaces as at planar surface 12 and a rim generally at numeral 14. On the rim, there are a plurality of teeth as at tooth 16. Each of these teeth has a curved outer edge 18, a tip 20, and a recessed inner edge 22. There is a hook angle 23 which is the angle between a radial line 24 and a line 25 which is an extension of the leading edge 26 of a composite polycrystalline diamond and carbide reinforcement 27, wherein radial line 24 contacts the inner corner 28 of leading edge 26. Preferably this hook angle is in the range of about 20° to about −20° and more preferably is about −10° (using the convention in circular saw blades that angles clockwise from the radius are negative and counter clockwise are positive). On the planar surface 12 adjacent the tip 20 of tooth 16 there is the composite polycrystalline diamond and carbide reinforcement 27. A suitable composite polycrystalline diamond and carbide reinforcement is commercially available from Sanvik Hard Materials located at Provo, Utah under part number PCDA 200. The body 10 of the saw blade also includes a central aperture 29 about which the blade rotates and a lock aperture 30. Two other teeth, tooth 32 and tooth 34, also have a tip composite polycrystalline diamond and carbide reinforcements 36 and 38 respectively. It will be seen that all the other teeth, as for example at teeth 42, 44 and 46, have carbide only tip reinforcements as at reinforcements 48, 50 and 52, respectively. A suitable carbide only reinforcement is commercially available from Sanvik Hard Materials under part number RAD80-100. The carbide only reinforcements also preferably have a hook angle of from about 20° to about −20° and more preferably about −10°. Like with the composite reinforcement, for the carbide only reinforcement the hook angle is the angle between a radial line contacting the inner corner of the leading edge of the reinforcement and a line which is an extension of the leading edge of the reinforcement.

Referring particularly to FIG. 1, it will be seen that there is a height H_{d} which is a radial distance between the center of the blade and the outermost corner of the composite polycrystalline diamond and carbide reinforcements as at reinforcement 36. For a conventional 7¼ inch circular saw blade, H_{d} may, for example, be 3.625 inches. There is also a height H_{c} which is a radial distance between the center of the blade and the outermost corner of the carbide only reinforcements as at reinforcement 48. For a conventional 7¼ circular saw blade H_{c} may, for example, be in the range from of 3.575 inches to 3.590 inches. Preferably the ratio of H_{c} to H_{d} will be in the range of about 1.0:1.0 to about 1.0:1.5. For the purposes of their disclosure, “height” will have the meaning defined in this paragraph.

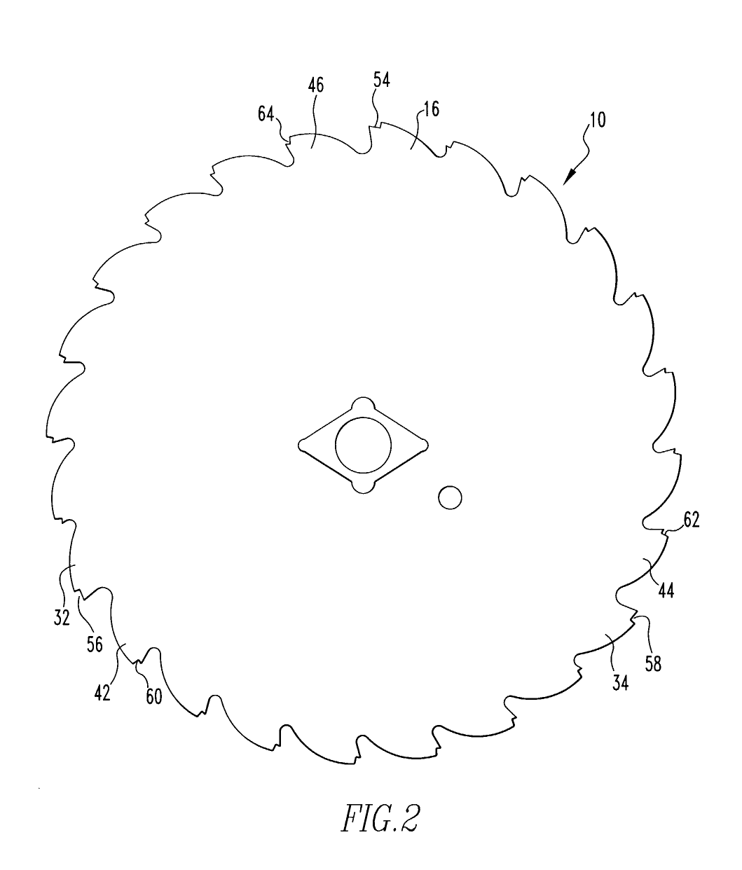

Referring to FIG. 2, the method of manufacturing the blade shown in FIG. 1 begins with a 1075 high carbon steel body 10 shown in FIG. 2 in which the polycrystalline diamond and carbide reinforcements and carbide reinforcements have not yet been fixed. At this stage, the teeth 16, 32 and 34 have respectively large reinforcement receiving recesses 54, 56 and 58 for receiving the composite polycrystalline and diamond and carbide reinforcements. The remaining teeth, such as teeth 42, 44 and 46, have smaller reinforcement receiving recesses as, respectively, recesses 60, 62 and 64 for receiving the carbide only reinforcements. The reinforcements are attached to the steel body 10 by conventional brazing techniques.

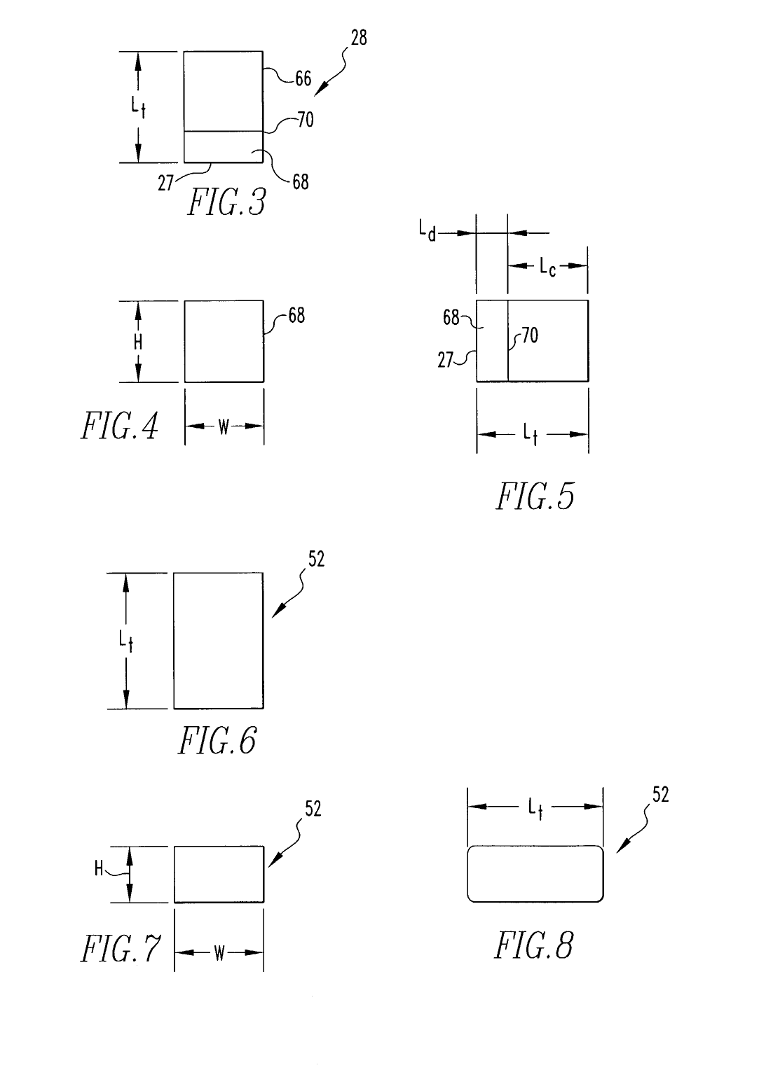

Referring to FIGS. 3-5, the reinforcement 27 is comprised of a composite of a carbide section 66 and a polycrystalline diamond section 68. Between the carbide section 66 and the polycrystalline diamond section 68 there is a cobalt interface layer 70. For a 7¼ inch circular saw blade the composite reinforcement 28 preferably has a thickness T_{d} of 0.090 inch, a width W_{d} of 0.090 inch and an overall length Lt of 0.125 inch. The overall length Lt is comprised of a length Lc of the carbide section 66 which is preferably 0.090 inch and a length Ld of the polycrystalline diamond section 68 which is preferably 0.030 inch.

Referring to FIGS. 6-8, the reinforcement 52 is comprised only of carbide. For a 7¼ inch circular saw blade the carbide only reinforcement 52 preferably has a thickness T_{c} of 0.052 inch, a width W_{c} of 0.100 inch and an overall length L_{c} of 0.150 inch.

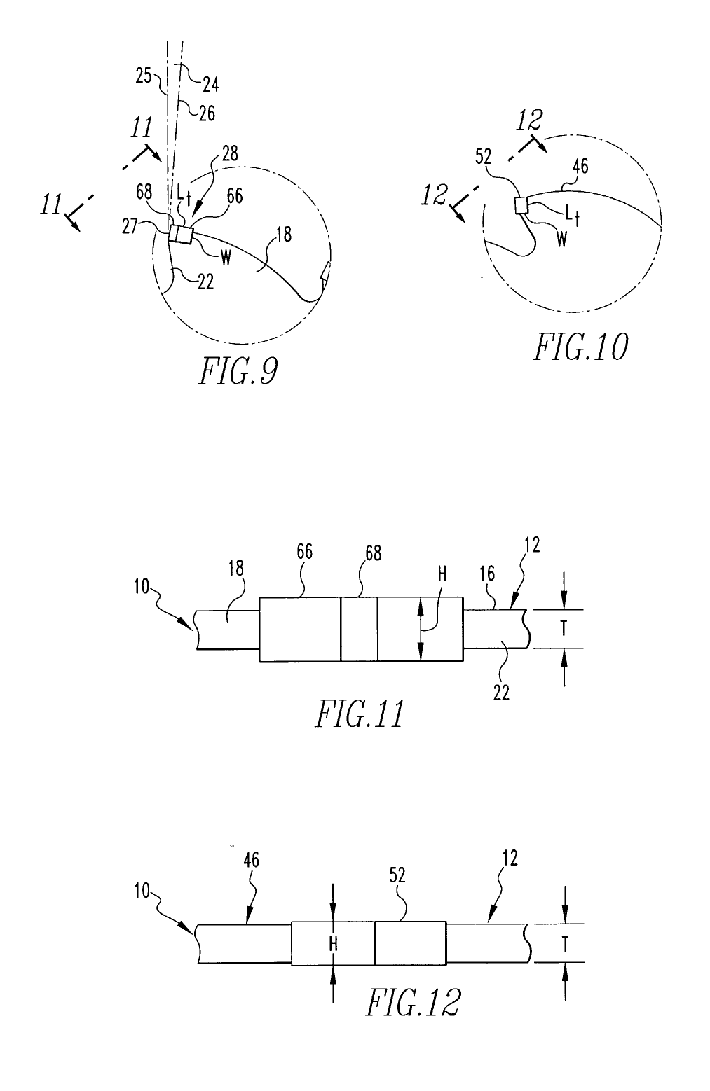

Referring to FIGS. 9 and 11, the positioning of the composite reinforcement 28 relative to the tooth 18 is shown in detail. The positioning of the dimensions Lt and W_{d} are as shown. The thickness T_{d} is perpendicular to the planar surface 12 of the blade 10. For a 7¼ inch circular saw blade the thickness T_{b} of the steel body 10 of the blade is preferably 0.054 inch.

Referring to FIGS. 10 and 12, the positioning of the carbide only reinforcement 52 relative to the tooth 46 is shown in detail. The positioning of the dimensions Lt and W_{c} are as shown. It will be appreciated that the thickness T_{c} is perpendicular to the planar surface 12 of the blade 10. The thickness T_{d} of the carbide and polycrystalline diamond composite reinforcement is equal to or greater than the thickness T_{c} of the carbide only reinforcement. For a 7¼ inch circular saw blade the thickness T_{b} of the steel body 10 of the blade is also 0.054 inch at this position. The ratio of the thickness T_{c} of the carbide only reinforcement to the thickness T_{d} of the composite polycrystalline diamond and carbide reinforcement is preferably in the range of from about 1.0:1.0 to about 1.0:2.0.

It will also be appreciated that the number of carbide only reinforcements will preferably be equal to or greater than the number of the polycrystalline diamond composite material reinforcements used. Preferably the ratio of the number of polycrystalline diamond composite material reinforcements or other carbon composite material reinforcements to the number of carbide only reinforcements will be in the range of about 1:1 to about 1:20.

The saw blade and its method of use are further described with reference to the following examples.

In the method of using this saw blade it has been found that the blade performs well at saw speeds of 3,600 RPM or 5,800 RPM which are standard speeds for 7¼ inch circular saws. On a cement, ground sand, and cellulosic fiber composite board of a thickness of 0.25 inch. This method is further described with reference to the following example.

### EXAMPLE 1

A saw as described above was used to cut a HARDIPLANK cement, sand and cellulosic fiber composite material board having a thickness of 0.25 inch which is commercially available from James Hardie Building Products, Inc. located at Mission Viejo, Calif. The saw was operated at a speed of 5,800 RPM. Under such conditions, the saw blade lasted for more than 3,280 board feet. It was also found that the cut made on the board was smooth and without excessive burred or frayed edges or other irregularities. Such a clean cut was believed to result from using a mixture of composite polycrystalline diamond reinforcements in combination with carbide only reinforcements as is disclosed herein.

### COMPARATIVE EXAMPLE 2

A conventional 7¼ inch circular saw blade which was similar to the blade used in Example 1 except that each of the blade tips had an all carbide tip similar to the all carbide tips described above was used to cut a HARDIPLANK board having a thickness of 0.25 inch. This saw blade was operated at 5,800 RPM. Under such conditions, the conventional all carbide tip blade lasted for approximately 66.67 board feet.

It will be appreciated that a saw blade has been described which cleanly and efficiently cuts cement, sand and cellulosic materials without excessive heat and blade warping.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A blade manufactured of steel for a saw comprising a generally planar member having a rim with a plurality of teeth, wherein the improvement comprises a carbon composite material reinforcement positioned on at least one of the teeth and a carbide only reinforcement positioned on at least another of the teeth.

2. The blade of claim 1 wherein the carbon composite material is a composite diamond material.

3. The blade of claim 2 wherein the composite material is a polycrystalline diamond composite material.

4. The blade of claim 3 wherein the composite material comprises a plurality of interconnected individual diamond crystals.

5. The blade of claim 4 wherein the individual diamond crystals are sintered together.

6. The blade of claim 2 wherein the carbon composite reinforcement is superimposed on a carbide substrate which is superimposed on the generally planar member.

7. The blade of claim 1 wherein a plurality of the teeth have a carbon composite material reinforcement and a plurality of the teeth have a carbide only reinforcement.

8. The blade of claim 7 wherein there are a first number of teeth having a carbon composite material reinforcement superimposed on a carbide substrate and a second number of teeth having a carbide only reinforcement and the ratio of the first number to the second number is from about 1:1 to about 1:20.

9. The blade of claim 7 wherein the carbon composite material reinforcement has a thickness and the carbide only reinforcement has a thickness and the thickness of the carbon composite material reinforcement is equal to or larger than the thickness of the carbide only reinforcement.

10. The blade of claim 9 wherein the ratio of the thickness of the carbide only reinforcement to the thickness of the carbon composite material reinforcement is in the range of from about 1.0:1.0 to about 1.0:2.0.

11. The blade of claim 9 wherein the blade is a circular saw blade.

12. The blade of claim 11 wherein there is a radial height at one of the carbon composite material reinforcements and a radial height at one of the carbide only reinforcements, and the height at said carbon composite material reinforcement is equal to or larger than the height at said carbide only reinforcement.

13. The blade of claim 12 wherein the ratio of the height at the carbide only reinforcement to the height at the carbon composite material reinforcement is in the range of about 1.0:1.0 to about 1.0:1.5.

14. The blade of claim 1 wherein each of the teeth has a tip and the carbon material composite is positioned on the tip of at least one of the teeth and the carbide only reinforcement is positioned on the tip of another of the teeth.

15. The blade of claim 14 wherein each of the teeth has a curved outer edge.

16. The blade of claim 14 wherein each of the teeth are curved inwardly from the tip of said teeth.

17. A steel circular saw blade comprising a generally planar member having a rim with a plurality of teeth, wherein a first number of said teeth each have a composite reinforcement comprising a polycrystalline diamond material superimposed on a carbide material and said composite reinforcement having a thickness and a height, and a second number of said teeth each have a carbide only reinforcement having a thickness and a height, and the ratio of the thickness of the carbide only reinforcement to the thickness of said carbide only reinforcement is in the range of from about 1.0:1.0 to about 1.0:2.0, the ratio of the height at said carbide only reinforcement to the height at said composite reinforcement is in the range of from about 1.0:1.0 to about 1.0 to about 1.5 and the ratio of the first number of teeth having a composite reinforcement to the second number of teeth having carbide only reinforcement is in the range of about 1.1 to about 1.20.

18. A blade for a saw manufactured of steel, said blade comprising a generally planar member having a rim with a plurality of integrally formed teeth, wherein the improvement comprises a first material reinforcement positioned on at least one of the teeth and a second material reinforcement positioned on at least another of the teeth, the second material reinforcement being a different material to the first material reinforcement

19. A circular saw blade manufactured of steel, the blade comprising:
a generally planar member;
a plurality of teeth extending radially from the planar member, the teeth being integrally formed with the planar member;
a first material reinforcement positioned on at least one of the teeth;
a second material reinforcement positioned on at least another of the teeth; wherein the second material reinforcement is manufactured from a different material to the first material reinforcement.

20. A blade as defined in claim 19, wherein the first material reinforcement is a carbon composite material.

21. A blade as defined in claim 20, wherein the carbon composite material is a composite diamond material.

22. A blade as defined in claim 21, wherein the second material reinforcement is a carbide only material.

23. A blade as defined in claim 22, wherein the thickness of the first material reinforcement differs from the thickness of the second material reinforcement.

24. A blade as defined in claim 23, wherein each of the teeth has a tip and the first material reinforcement and the second material reinforcement are posited only on the tips of the teeth.

25. The blade as defined in claim 24, wherein there are a first number of teeth having a first material reinforcement and a second number of teeth having a second material reinforcement and the ratio of the first number of teeth to the second number of teeth is from about 1:1 to about 1:20.
